(19) United States
(12) Patent Application Publication
(10) Pub. No.: US 2006/0142407 A1
(43) Pub. Date: Jun. 29, 2006

(54) Rigid polyurethane foams, a process for their production and their use

(76) Inventors: Christoph Hollmann, Leichlingen (DE); Dieter Seidel, Koln (DE); Klaus-Werner Huland, Wermelskirchen (DE)

Correspondence Address: BAYER MATERIAL SCIENCE LLC, 100 BAYER ROAD, PITTSBURGH, PA, 15205, US

(21) Appl. No.: 11/305,956

(22) Filed: Dec. 19, 2005

(30) Foreign Application Priority Data
Dec. 24, 2004 (DE) 102004062540.9

(51) Int. Cl. C08G 18/00

(52) U.S. Cl. 521/172

(57) ABSTRACT

Predominantly open-cell, cold-formable, compressed rigid polyurethane foams are produced from an isocyanate component satisfying specified criteria and an isocyanate-reactive component composed of at least 5 polyhydroxyl compounds satisfying specified criteria. These foams are produced by a double conveyor belt process. The foams of the present invention are particularly useful for the manufacture of soft trim for cars, especially inside roof linings, roof stiffening boards and column trim.

### BACKGROUND OF THE INVENTION

The present invention relates to predominantly open-cell, cold-formable, compressed rigid polyurethane foams, to a process for their production and to their use for the manufacture of soft trim for cars, especially inside roof linings, roof stiffening boards and column trim.

Rigid polyurethane (PUR) foams as an intermediate layer of sandwich structures, and their use for the manufacture of soft trim for cars, are known.

Sandwich boards for use as inside roof linings, roof stiffening or column trim are usually manufactured by the cold-forming process in which the rigid PUR foam board is provided on both sides with a thermosetting adhesive and reinforcing materials, such as glass fiber and/or natural fiber mats or non-woven fabrics and/or glass fiber rovings, as well as facings made of paper, thermoplastic sheets and/or non-woven fabrics and optionally decorative layers, to form a sandwich which is compressed in a mold at temperatures of 100 to 150° C.

The use of thermo-formable rigid PUR foams for the manufacture of soft trim for motor vehicles is described, e.g., in Kunststoff-Handbuch, Polyurethane, Volume VII, Carl Hanser Verlag, Munich, Vienna, 2nd edition, 1983, pp 318-319.

In EP-A 0 239 906, thermo-formable, heat-crosslinkable rigid PUR foams are produced by reacting polyisocyanates with polyol components on a double conveyor belt. ε-Caprolactam and/or nonylphenol are used as compounds for blocking NCO groups so that, during thermo-forming, the foam is transformed from a rather thermoplastic material to a thermosetting material by means of a second reaction.

EP-A 0 437 787 describes a discontinuous process for the production of open-cell, cold-formable rigid PUR foams with densities of 25-30 kg/m³ by reaction of mixtures of diphenylmethane diisocyanates (MDI) and polyphenylpolymethylene polyisocyanates, having an MDI content of 70 to 90 wt. %, with a component composed of 50 to 70 wt. % of a difunctional and/or trifunctional polyoxyalkylene polyol having a hydroxyl number of 28 to 600, 20 to 35 wt. % of a difunctional phthalic acid polyester having a hydroxyl number of 150 to 440, 2 to 10 wt. % of glycerol, 3.5 to 7 wt. % of water, 0.3 to 1 wt. % of an incorporatable tertiary amine catalyst and 0.1 to 2 wt. % of a silicone foam stabilizer.

According to DE-A 4 333 795, thermoplastically formable rigid PUR foams can be produced by reaction of mixtures of diphenylmethane diisocyanates (MDI) and polyphenylpolymethylene polyisocyanates with mixtures of polyhydroxyl compounds which contain 40 to 60 wt. % of a trifunctional polyoxyalkylene polyol having a hydroxyl number of 350 to 500, 15 to 30 wt. % of a difunctional polyoxyalkylene polyol having a hydroxyl number of 200 to 350, 5 to 20 wt. % of a difunctional to trifunctional polyoxyalkylene polyol having a hydroxyl number of 25 to 40 and 15 to 30 wt. % of a dialkylene glycol. The foam blocks, produced continuously or batchwise, have densities of 18 to 45 kg/m³. The foam sheets needed to make inside roof linings by the cold-forming or thermo-forming process, in preferred wall thicknesses of 6-20 mm, are obtained from the blocks by horizontal cutting.

Disadvantages of the process for the production of foam sheets from rigid PUR foam blocks include the expense of cutting or sawing and the resulting waste from the top end, bottom and edge regions of the blocks.

### SUMMARY OF THE INVENTION

The object of the present invention is to provide a method for continuously producing, on a double conveyor belt, predominantly open-cell rigid PUR foam boards capable of being compressed by the cold-forming process to make soft trim for cars.

Surprisingly, this object is achieved with the rigid PUR foams of the present invention produced from the polyisocyanate and isocyanate-reactive components described in greater detail below.

### DETAILED DESCRIPTION OF THE INVENTION

The present invention is directed to predominantly open-cell, cold-formable, compressed rigid polyurethane (PUR) foams obtainable by reacting

A) a polyisocyanate component which includes
a) an organic polyisocyanate composed of
a1) 70 to 90 wt. % of monomeric diphenylmethane diisocyanate containing 18 to 32 wt. %, based on the total weight of organic polyisocyanate component a), of 2,4′-diphenylmethane diisocyanate, and
a2) 10 to 30 wt. % of polyphenylpolymethylene polyisocyanate
   with an isocyanate-reactive component B) which includes
b) a combination of polyhydroxyl compounds including:
b1) 20 to 35 wt. %, based on the total weight of component B), of at least one polyoxyalkylene polyol having a hydroxyl number of 25 to 40 and a functionality of 2 to 3,
b2) 20 to 30 wt. %, based on the total weight of component B), of at least one polyoxyalkylene polyol having a hydroxyl number of 400-650 and a functionality of 3 to 4,
b3) 5 to 15 wt. %, based on the total weight of component B), of at least one polyoxyalkylene polyol having a hydroxyl number of 150-550 and a functionality of 2,
b4) 15 to 30 wt. %, based on the total weight of component B), of at least one difunctional polyester having a hydroxyl number of 200-350, and
b5) 4 to 7 wt. %, based on the total weight of component B), of glycerol,
   and other materials which are preferably included in component B) that include:
c) 3.5 to 5.5 wt. %, based on the total weight of component B), of water,
d) 0.5 to 4 wt. %, based on the total weight of component B), of at least one catalyst,
e) 0.5 to 2 wt. %, based on the total weight of component B), of at least one foam stabilizer,
f) 1 to 3.5 wt. %, based on the total weight of component B), of cell opener and
g) optionally, auxiliary substances and/or additives,
   the NCO index being 95 to 125, preferably 100 to 120.

The rigid PUR foams of the present invention are preferably produced by the double conveyor belt process. They are preferably used for the manufacture of soft trim for cars, especially inside roof linings, roof stiffening boards and column trim.

The invention is also directed to a continuous process for the production of cold-formable, compressed, open-cell rigid polyurethane foams by the double conveyor belt process, wherein
I) the polyisocyanate component A) and the isocyanate-reactive component B) are mixed in a mixer at temperatures of 20 to 35° C. in a ratio such that the NCO index is 95 to 125,
II) the mixture from I) is introduced between the two facings of a double conveyor belt at temperatures of 40 to 100° C., and
III) the foam-forming mixture foams as the conveyor belt moves, the foam is cooled, and after cooling, optionally, one or both of the facings are removed and, optionally, the cooled product is cut.

Component A) used in this process must include an organic polyisocyanate component a) made up of
a1) 70 to 90 wt. % of monomeric diphenylmethane diisocyanate containing 18 to 32 wt. %, based on the total weight of organic polyisocyanate component a), of 2,4′-diphenylmethane diisocyanate, and
a2) 10 to 30 wt. % of polyphenylpolymethylene polyisocyanate.

Component B) used in this process is an isocyanate-reactive component which must include polyhydroxyl compounds b) which include
b1) 20 to 35 wt. %, based on the total weight of component B), of at least one polyoxyalkylene polyol having a functionality of 2 to 3 and a hydroxyl number of 25 to 40,
b2) 20 to 30 wt. %, based on the total weight of component B), of at least one polyoxyalkylene polyol having a functionality of 3 to 4 and a hydroxyl number of 400 to 650,
b3) 5 to 15 wt. %, based on the total weight of component B), of at least one polyoxyalkylene polyol having a functionality of 2 and a hydroxyl number of 150 to 550,
b4) 15 to 30 wt. %, based on the total weight of component B), of at least one polyester polyol having a functionality of 2 and a hydroxyl number of 200 to 350, and
b5) 4 to 7 wt. %, based on the total weight of component B), of glycerol.

Additional materials which are preferably included in component B) include:
c) 3.5 to 5.5 wt. %, based on the total weight of component B), of water as blowing agent,
d) 0.5 to 4 wt. %, based on the total weight of component B), of at least one catalyst,
e) 0.5 to 2 wt. %, based on the total weight of component B), of at least one foam stabilizer,
f) 1 to 3.5 wt. %, based on the total weight of component B), of cell opener and
g) optionally, auxiliary substances and/or additives.

The catalysts d) include any of the compounds that accelerate the reaction of the reactants containing reactive hydrogen atoms, especially hydroxyl groups, and the water with the organic polyisocyanates. Suitable catalysts are metal-organic compounds, preferably organic tin compounds such as tin(II) salts of organic carboxylic acids, for example tin(II) acetate, tin(II) octanoate, tin(II) ethylhexanoate and tin(II) laurate; the dialkyltin(IV) salts of organic carboxylic acids, for example dibutyltin diacetate, dibutyltin dilaurate, dibutyltin maleate and dioctyltin diacetate; tertiary amines such as triethylamine, tributylamine, dimethylcyclohexylamine, dimethylbenzylamine, N-methylimidazole, N-methyl-, N-ethyl- and N-cyclohexylmorpholine, N,N,N′,N′-tetramethylethylenediamine, N,N,N′,N′-tetramethylbutylenediamine, N,N,N′,N′-tetramethyl-1,6-hexylenediamine, pentamethyldiethylenetriamine, tetramethyldiaminoethyl ether, bis(dimethylaminopropyl)urea, dimethylpiperazine, 1,2-dimethylimidazole, 1-azabicyclo[3,3,0]octane and 1,4-diazabicyclo[2,2,2]octane; and alkanolamine compounds such as triethanolamine, triisopropanolamine, N-methyl- and N-ethyldiethanolamine and dimethylethanolamine. Other suitable catalysts are tris(dialkylamino)-s-hexahydrotriazines, especially tris(N,N-dimethylamino)-s-hexahydrotriazine; tetraalkylammonium salts, for example N,N,N-trimethyl-N-(2-hydroxypropyl)formate, and N,N,N-trimethyl-N-(2-hydroxypropyl)2-ethylhexanoate; tetraalkylammonium hydroxides such as tetramethylammonium hydroxide; alkali metal hydroxides such as sodium hydroxide; alkali metal alcoholates such as sodium methylate and potassium isopropylate; and alkali metal or alkaline earth metal salts of fatty acids having 1 to 20 C atoms and optionally lateral OH groups.

It is particularly preferable to use isocyanate-reactive tertiary amines such as N,N-dimethylaminopropylamine, bis(dimethylaminopropyl)amine, N,N-dimethylaminopropyl-N′-methylethanolamine, dimethylaminoethoxyethanol, bis(dimethylaminopropyl)amino-2-propanol, N,N-dimethylaminopropyldipropanolamine, N,N,N′-trimethyl-N′-hydroxyethylbisaminoethyl ether, N,N-dimethylaminopropylurea, N-(2-hydroxypropyl)imidazole, N-(2-hydroxyethyl)imidazole and N-(2-aminopropyl)imidazole, and/or the reaction products of ethyl acetoacetate, polyether polyols and 1-(dimethylamino)-3-aminopropane described in EP-A 0 629 607 as the catalyst in the practice of the present invention.

The polyisocyanate component used in the practice of the present invention includes mixtures of 4,4′-, 2,4′- and 2,2′-diphenylmethane diisocyanates and polyphenylpolymethylene polyisocyanates (crude MDI). Types of crude MDI with a diphenylmethane diisocyanate isomer content of 70 to 90 wt. % and especially a 2,4′-diphenylmethane diisocyanate content of 18 to 32 wt. %, based on the total crude MDI mixture used, have proven to be particularly suitable.

The component b1) may be any of the known difunctional and/or trifunctional polyoxyalkylenepolyols having a hydroxyl number ranging from 25 to 40, preferably, those obtained by reacting ethylene oxide and/or propylene oxide with one or more trihydric polyols such as glycerol or trimethylolpropane.

The component b2) may be any of the known trifunctional and/or tetrafunctional polyoxyalkylenepolyols having a hydroxyl number ranging from 400 to 650, preferably, those obtained by reacting ethylene oxide and/or propylene oxide with one or more polyols or amines such as glycerol, trimethylolpropane, triethanolamine, ethylenediamine, ortho-toluenediamine, mixtures of sugar and/or sorbitol with glycols, etc.

The component b3) may be any of the known difunctional polyoxyalkylene polyols having a hydroxyl number ranging from 150 to 550, preferably those obtained by reacting ethylene oxide and/or propylene oxide with one or more glycols such as ethylene glycol, diethylene glycol, 1,2- or 1,3-propylene glycol, 1,4-butanediol, etc.

The component b4) may be any of the known difunctional polyesters having a hydroxyl number ranging from 200 to 350, preferably, those prepared by esterifying phthalic anhydride and/or adipic acid with ethylene glycol, diethylene glycol, propylene glycol, etc. It is particularly preferred to use a polyester obtained from phthalic anhydride, diethylene glycol and ethylene oxide.

The component e) is preferably from 0.5 to 2 wt. % of any of the known silicone foam stabilizers.

Examples of suitable foam stabilizers e) are siloxane/polyoxyalkylene copolymers, organopolysiloxanes, ethoxylated fatty alcohols and alkylphenols, and ricinoleic acid esters.

Effective cell openers f) are, e.g., paraffins, polybutadienes, fatty alcohols and dimethylpolysiloxanes.

Examples of auxiliary substances and additives g) that can optionally be used in the practice of the present invention are emulsifiers, reaction retarders, ageing and weathering stabilizers, plasticizers, inorganic flame retardants, phosphorus-containing and/or halogen-containing organic flameproofing agents, substances with a fungistatic and/or bacteriostatic action, pigments and dyes, and the conventional organic and inorganic fillers. Examples of emulsifiers which may be mentioned are ethoxylated alkylphenols, alkali metal salts of fatty acids, alkali metal salts of sulfated fatty acids, alkali metal salts of sulfonic acids and salts of fatty acids and amines.

Further details on the mode of use and action of the above-mentioned auxiliary substances and additives are described e.g. in Kunststoff-Handbuch, Polyurethane, volume VII, Carl Hanser Verlag, Munich, Vienna, 2nd edition, 1983.

The foams of the present invention are produced using double conveyor belt technology. It has proven to be advantageous to operate by the two-component process and to combine the components b)-g) into a processing component (B) and react this with the organic polyisocyanates a) as a processing component (A).

The processing components (A) and (B) are mixed in a mixer at temperatures of 15 to 40° C., preferably of 20 to 35° C., in a ratio corresponding to an index of 95 to 125, preferably of 100 to 120.

A low-pressure mixing head, for example, can be used as the mixer.

The mixture of (A) and (B) is introduced continuously between two facings, for example, by means of an oscillating mixing head, so as to foam up between the conveyor belts heated to 40-90° C. After the foam has formed on the conveyor belts and the foam has cooled, optionally, one or both facings are removed and the foam produced is optionally cut.

The compressed rigid PUR foams produced by the process according to the invention have a density of 20 to 50 kg/m³, preferably of 25 to 45 kg/m³ and most preferably of 30 to 40 kg/m³.

The cell openness, measured according to DIN EN ISO 4590 without correction, is between 30 and 90%.

The rigid PUR foams produced by the process according to the invention are particularly suitable as intermediate layers for the manufacture of sandwich elements by the cold-forming process and for use as soft trim for cars, especially as inside roof linings, roof stiffening board and column trim.

The invention is illustrated in greater detail in the Examples which follow.

### EXAMPLES

### Examples 1-3 and Comparative Examples

Commercially available products used:

DABCO® NE-1060 from Air Products GmbH—incorporatable tertiary amine catalyst

Niax® Silicone SR 272 from GE Silicones—stabilizer, siloxane/polyalkylene oxide copolymer

Ortegol® 501 from Degussa Goldschmidt AG—cell opener, polybutadiene/diisononyl phthalate

Production of the Rigid PUR Foams

### Example 1

A mixture (component B) of

25.10 parts by weight of a polyether polyol (b1) based on glycerol/propylene oxide/ ethylene oxide, of OH number 28 mg KOH/g and functionality 3,

14.65 parts by weight of a polyether polyol (b2) based on trimethylolpropane/propylene oxide, of OH number 550 mg KOH/g and functionality 3,

10.00 parts by weight of a polyether polyol (b2) based on triethanolamine/propylene oxide, of OH number 500 mg KOH/g and functionality 3,

23.65 parts by weight of a polyesterether polyol (b4) based on phthalic anhydride/diethylene glycol/ethylene oxide, of OH number 300 mg KOH/g and functionality 2,

8.19 parts by weight of a polyether polyol (b3) based on propylene glycol/propylene oxide/ethylene oxide, of OH number 190 mg KOH/g and functionality 2,

5.92 parts by weight of glycerol (b5),

1.97 parts by weight of the reaction product of ethyl acetoacetate, a polyether polyol based on trimethylolpropane/propylene oxide (OH number 550 mg KOH/g) and 1-(dimethylamino)-3-aminopropane, analogous to EP 0 629 607,

2.00 parts by weight of a tertiary amine (d) (DABCO® NE-1060 from Air Products),

1.48 parts by weight of a silicone foam stabilizer (e) (Niax® Silicone SR 272 from GE Silicones),

2.50 parts by weight of a cell opener (f) (Ortegol® 501 from Degussa Goldschmidt AG) and

4.54 parts by weight of water (c)

was mixed with

158.0 parts by weight of a mixture (component A) of diphenylmethane diisocyanates and polyphenylpolymethylene polyisocyanates having a diphenylmethane diisocyanate isomer content of 88 wt. % and an NCO content of 32.5 wt. %.

### Example 2

A mixture (component B) of

25.10 parts by weight of a polyether polyol based on glycerol/propylene oxide/ethylene oxide, of OH number 28 mg KOH/g and functionality 3,

14.65 parts by weight of a polyether polyol based on trimethylolpropane/propylene oxide, of OH number 550 mg KOH/g and functionality 3,

10.00 parts by weight of a polyether polyol based on ethylenediamine/propylene oxide, of OH number 630 mg KOH/g and functionality 4,

23.65 parts by weight of a polyesterether polyol based on phthalic anhydride/ diethylene glycol/ethylene oxide, of OH number 300 mg KOH/g, and functionality 2,

8.19 parts by weight of a polyether polyol based on propylene glycol/propylene oxide/ethylene oxide, of OH number 190 mg KOH/g and functionality 2,

5.92 parts by weight of glycerol,

1.97 parts by weight of the reaction product of ethyl acetoacetate, a polyether polyol based on trimethylolpropane/propylene oxide (OH number 550 mg KOH/g) and 1-(dimethylamino)-3-aminopropane, analogous to EP 0 629 607,

2.00 parts by weight of a tertiary amine, DABCO® NE-1060 from Air Products,

1.48 parts by weight of a silicone foam stabilizer, Niax® Silicone SR 272 from GE Silicones,

1.50 parts by weight of a cell opener, Ortegol® 501 from Degussa Goldschmidt AG, and

4.54 parts by weight of water

was mixed with

161.0 parts by weight of a mixture (component A) of diphenylmethane diisocyanates and polyphenylpolymethylene polyisocyanates having a diphenylmethane diisocyanate isomer content of 88 wt. % and an NCO content of 32.5 wt. %.

### Example 3

A mixture (component B) of

25.10 parts by weight of a polyether polyol based on glycerol/propylene oxide/ethylene oxide, of OH number 28 mg KOH/g and functionality 3,

14.65 parts by weight of a polyether polyol based on trimethylolpropane/propylene oxide, of OH number 550 mg KOH/g and functionality 3,

10.00 parts by weight of a polyether polyol based on ethylenediamine/propylene oxide, of OH number 630 mg KOH/g and functionality 4,

23.65 parts by weight of a polyesterether polyol based on phthalic anhydride/diethylene glycol/ethylene oxide, of OH number 300 mg KOH/g and functionality 2,

8.19 parts by weight of a polyether polyol based on propylene glycol/propylene oxide/ethylene oxide, of OH number 190 mg KOH/g and functionality 2,

5.92 parts by weight of glycerol,

1.97 parts by weight of the reaction product of ethyl acetoacetate, a polyether polyol based on trimethylolpropane/propylene oxide (OH number 550 mg KOH/g) and 1-(dimethylamino)-3-aminopropane, analogous to EP 0 629 607,

2.00 parts by weight of a tertiary amine, DABCO® NE-1060 from Air Products,

1.48 parts by weight of a silicone foam stabilizer, Niax Silicone SR 272 from GE Silicones,

1.50 parts by weight of a cell opener, Ortegol® 501 from Degussa Goldschmidt AG, and

4.54 parts by weight of water

was mixed with

163.0 parts by weight of a mixture (component A) of diphenylmethane diisocyanates and polyphenylpolymethylene polyisocyanates having a diphenylmethane diisocyanate isomer content of 70 wt. % and an NCO content of 32.0 wt. %.

### Comparative Example 1

A mixture (component B) of

26.60 parts by weight of a polyether polyol based on glycerol/propylene oxide/ethylene oxide, of OH number 28 mg KOH/g and functionality 3,

24.65 parts by weight of a polyether polyol based on trimethylolpropane/propylene oxide, of OH number 550 mg KOH/g and functionality 3,

24.65 parts by weight of a polyesterether polyol based on phthalic anhydride/diethylene glycol/ethylene oxide, of OH number 300 mg KOH/g and functionality 2,

8.19 parts by weight of a polyether polyol based on propylene glycol/propylene oxide/ethylene oxide, of OH number 190 mg KOH/g and functionality 2,

5.92 parts by weight of glycerol,

1.97 parts by weight of the reaction product of ethyl acetoacetate, a polyether polyol based on trimethylolpropane/propylene oxide (OH number 550 mg KOH/g) and 1-(dimethylamino)-3-aminopropane, analogous to EP 0 629 607,

2.00 parts by weight of a tertiary amine, DABCO® NE-1060,

1.48 parts by weight of a silicone foam stabilizer, Niax® Silicone SR 272, and

4.54 parts by weight of water

was mixed with

160 parts by weight of a mixture (component A) of diphenylmethane diisocyanates and polyphenylpolymethylene polyisocyanates having a diphenylmethane diisocyanate isomer content of 88 wt. % and an NCO content of 32.5 wt. %.

### Comparative Example 2

A mixture (component B) of

25.10 parts by weight of a polyether polyol based on glycerol/propylene oxide/ethylene oxide, of OH number 28 mg KOH/g and functionality 3,

14.65 parts by weight of a polyether polyol based on trimethylolpropane/propylene oxide, of OH number 550 mg KOH/g and functionality 3,

10.00 parts by weight of a polyether polyol based on ethylenediamine/propylene oxide, of OH number 630 mg KOH/g and functionality 4,

23.65 parts by weight of a polyesterether polyol based on phthalic anhydride/diethylene glycol/ethylene oxide, of OH number 300 mg KOH/g and functionality 2,

8.19 parts by weight of a polyether polyol based on propylene glycol/propylene oxide/ethylene oxide, of OH number 190 mg KOH/g and functionality 2,

5.92 parts by weight of glycerol,

1.97 parts by weight of the reaction product of ethyl acetoacetate, a polyether polyol based on trimethylolpropane/propylene oxide (OH number 550 mg KOH/g) and 1-(dimethylamino)-3-aminopropane, analogous to EP 0 629 607,

2.00 parts by weight of a tertiary amine, DABCO® NE-1060 from Air Products,

1.48 parts by weight of a silicone foam stabilizer, Niax® Silicone SR 272 from GE Silicones,

1.50 parts by weight of a cell opener, Ortegol® 501 from Degussa Goldschmidt AG, and

4.54 parts by weight of water

was mixed with

166 parts by weight of a mixture (component A) of diphenylmethane diisocyanates and polyphenylpolymethylene polyisocyanates having a diphenylmethane diisocyanate isomer content of 45 wt. % and an NCO content of 31.5 wt. %.

Corresponding to an NCO index of 110, the component A and the component B were intimately mixed at 23° C. and filled into a paper-lined wooden box (volume 61), where they were foamed.

The foams produced had the following properties:

TABLE

| | | | | Comparative | Comparative |
|---|---|---|---|---|---|
| cream | Example 1 | Example 2 | Example 3 | Example 1 | Example 2 |
| Cream time [s] | 18 | 18 | 20 | 22 | 23 |
| Gel time [s] | 42 | 43 | 42 | 48 | 42 |
| Density¹ [kg/m³] | 28 | 24 | 32 | 30 | 29 |
| Cell openness² [%] | 98 | 97 | 97 | 79 | 98 |
| Tensile strength³ [kPa] | 238 | 236 | 246 | 281 | 176 |
| Elongation at break³ [%] | 28 | 27 | 19 | 25 | 14 |

¹according to DIN 53420,
²according to DIN EN IS 4590 (uncorrected),
³according to DIN 53430

The foams according to Examples 1 to 3 had good formability. The formulation of Example 2, when applied to a double conveyor belt, produced boards of wall thickness 13.5 mm which, after removal of the facings, could be processed to inside roof linings by the cold-forming process without the foam breaking. The foam had a density of 38 kg/m³, a cell openness of 41%, a tensile strength of 400 kPa and an elongation at break of 22%.

Foams produced from the formulation of Comparative Example 1 did not possess a sufficient cell openness for the manufacture of rigid PU foam boards that could be processed by the cold-forming process.

Foams produced from the formulation of Comparative Example 2 did not possess adequate elongation and forming properties for the manufacture of inside roof linings by the cold-forming process.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A continuous process for the production of cold-formable, compressed, open-cell rigid polyurethane foams by a double conveyor belt process comprising:
I) mixing
component A) comprising
a) an organic polyisocyanate component comprising:
a1) from 70 to 90 wt. %, based on total weight of A), of monomeric diphenylmethane diisocyanate containing from 18 to 32 wt. % of 2,4′-diphenylmethane diisocyanate, and
a2) from 10 to 30 wt. %, based on total weight of A), of polyphenylpolymethylene polyisocyanate
with
component B) comprising
b) a combination of polyhydroxyl compounds comprising:
b1) from 20 to 35 wt. %, based on total weight of component B), of at least one polyoxyalkylene polyol having a functionality of from 2 to 3 and a hydroxyl number of from 25 to 40,
b2) from 20 to 30 wt. %, based on total weight of component B), of at least one polyoxylalkylene polyol having a functionality of from 3 to 4 and a hydroxyl number of from 400 to 650,
b3) from 5 t 15 wt. %, based on total weight of component B), of at least one polyoxyalkylene polyol having a functionality of 2 and a hydroxyl number of from 150 to 550,
b4) from 15 to 30 wt. %, based on total weight of component B), of at least one polyester polyol having a functionality of 2 and a hydroxyl number of from 200 to 350, and
b5) from 4 to 7 wt. %, based on total weight of component B), of glycerol,
c) from 3.5 to 5.5 wt. %, based on total weight of component B), of water,
d) from 0.5 to 4 wt. %, based on total weight of component B), of at least one catalyst,
e) from 0.5 to 2 wt. %, based on total weight of component B), of at least one foam stabilizer,
f) from 1 to 3.5 wt. %, based on total weight of component B), of a cell opener, and
g) from 0 to 7 wt. %, based on total weight of component B), of one or more auxiliary substances and/or additives
in a mixer at a temperature of from 20 to 35° C. and an NCO index of from 95to125,
II) introducing the mixture from I) between two facings of a double conveyor belt at a temperature of from 40 to 100° C., and
III) allowing the mixture introduced in II) to form a foam,
IV) cooling the foam formed in III), and
V) optionally removing one or both of the facings and, optionally, cutting the cooled foam.

2. A cold-formable, compressed, open-cell rigid polyurethane foam comprising the reaction product of
1) component A) comprising
a) an organic polyisocyanate component comprising:
a1) from 70 to 90 wt. %, based on total weight of A), of monomeric diphenylmethane diisocyanate containing from 18 to 32 wt. % of 2,4′-diphenylmethane diisocyanate, and
a2) from 10 to 30 wt. %, based on total weight of A), of polyphenylpolymethylene polyisocyanate
with
2) component B) comprising
b) a combination of polyhydroxyl compounds comprising:
b1) from 20 to 35 wt. %, based on total weight of component B), of at least one polyoxyalkylene polyol having a functionality of from 2 to 3 and a hydroxyl number of from 25 to 40,
b2) from 20 to 30 wt. %, based on total weight of component B), of at least one polyoxylalkylene polyol having a functionality of from 3 to 4 and a hydroxyl number of from 400 to 650,
b3) from 5 t 15 wt. %, based on total weight of component B), of at least one polyoxyalkylene polyol having a functionality of 2 and a hydroxyl number of from 150 to 550,
b4) from 15 to 30 wt. %, based on total weight of component B), of at least one polyester polyol having a functionality of 2 and a hydroxyl number of from 200 to 350, and
b5) from 4 to 7 wt. %, based on total weight of component B), of glycerol,
c) from 3.5 to 5.5 wt. %, based on total weight of component B), of water,
d) from 0.5 to 4 wt. %, based on total weight of component B), of at least one catalyst,
e) from 0.5 to 2 wt. %, based on total weight of component B), of at least one foam stabilizer,
f) from 1 to 3.5 wt. %, based on total weight of component B), of a cell opener, and
g) from 0 to 7 wt. %, based on total weight of component B), of one or more auxiliary substances and/or additives
at an NCO index of from 95 to 125.

3. The foam of claim 2 produced at an NCO index of from 100 to 120.

4. The foam of claim 2 in which the foam stabilizer e) is a silicone.

5. Soft trim for an automobile comprising the foam of claim 2.
